(19) United States
(12) Patent Application Publication
(10) Pub. No.: US 2010/0213739 A1
(43) Pub. Date: Aug. 26, 2010

(54) PANEL PART FOR A MOTOR VEHICLE, AND METHOD FOR PRODUCING A PANEL PART

(75) Inventors: Jan Krueger, Stuttgart (DE); Jens Humpenoeder, Ulm (DE); Ulrich Seiler, Boeblingen (DE)

Correspondence Address: PATENT CENTRAL LLC;Stephan A. Pendorf, 1401 Hollywood Boulevard, Hollywood, FL, 33020, US

(73) Assignee: DAIMLER AG, Stuttgart (DE)

(21) Appl. No.: 12/738,126

(22) PCT Filed: Aug. 12, 2008
(86) PCT No.: PCT/EP08/06619

§ 371 Date: Apr. 15, 2010

(30) Foreign Application Priority Data
Oct. 19, 2007 (DE) 10 2007 050 125.2

(51) Int. Cl. B62D 29/04; B29C 45/14

(52) U.S. Cl. 296/191; 264/272.11

(57) ABSTRACT

The invention relates to a panel part of the outer panel or inner panel of a motor vehicle. Said panel part comprises a base body (10) at least partially consisting of a transparent plastic material (12) carrying at least one solar module (16), the plastic material entirely surrounding the solar module (16) in a form-fitting manner, at least on the sun-facing side or the outer side of the panel part. The sun-facing side or outer side of the panel part is covered, at least in sections, by an essentially opaque and/or coloured covering layer (14) comprising a recess (18) associated with the solar module, in the arrangement region of the solar module (16).

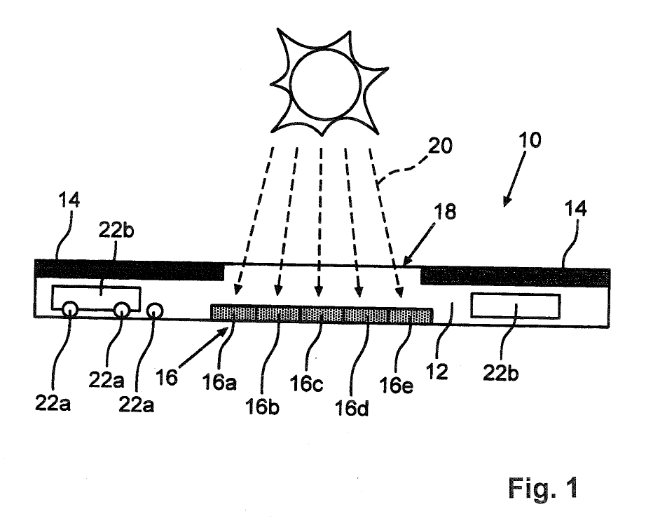

The invention relates to a panel part of the outer or inner panel of motor vehicles of the type given in the preamble of claim 1. The invention further relates to a method for producing such a panel part of the type specified in the preamble of claim 10.

Such a panel part and such a method are for example already known from DE 10 2005 050 372 A1. The outer panel part formed as a covering part thereby comprises a base body consisting of a transparent plastic material and whose outer side is covered by a transparent covering layer. The base body further comprises glued or molded metal reinforcements and a solar module and carries a colored interior coating film, by means of which the base body obtains a perceivable color.

It is the object of the present invention to provide a panel part of the above-mentioned type, which has improved optical properties.

The object is solved according to the invention by a panel part with the characteristics of claim 1 and a method for producing a panel part with the characteristics of claim 10. Advantageous embodiments with useful and non-trivial further refinements of the invention are given in the respective dependent claims, wherein advantageous arrangements of the method—as far as they can be used—should be viewed as advantageous arrangements of the method and vice versa.

A panel part according to the invention is designed in such a manner that the plastic material entirely surrounds the solar module (16) at least on the sun-facing side or outer side of the panel part in a form-fitting manner. The solar module is thereby connected to the plastic material in a form-fitting manner, as can for example be obtained by the molding of the solar module in plastic material. The solar module is hereby integrated in the base body over its entire planar extension in a force-fitting manner.

The integral design of the panel part with the solar module is the advantage of this arrangement, where special fastening devices for the solar module can be foregone. Especially large-area solar modules can hereby be connected to the panel parts in a simple manner and be built into the motor vehicle as finished module. The solar modules are typically constructed by an array of several solar cells, or also as thin layer solar cell, for example as an amorphous solar cell on a supporting film.

By the large-area form- and force-fitting connection of the solar module to the base body, it is further possible to design the bottom side of the solar module essentially free, that is, not molded by plastic material. This offers advantages for a possibly necessary service or the fitting of media connections.

A panel part having improved optical properties is created according to a further arrangement of the invention in that the panel part has a covering layer at the upper side. The upper side is the sun-facing side or also the outer side of the panel part. The covering layer has a recess associated with the solar module at least in the arrangement region thereof. Such a recess thereby enables an improved light entry into the plastic material of the base body, which is at least transparent at this location, whereby the efficiency of the solar module is increased advantageously due to the decreased optical scattering and absorption losses.

Due to the comparatively low weight of the panel part compared to sheet metal or glass panel parts, the energy requirement of the associated vehicle can additionally be reduced in an advantageous manner. The solar module can thereby comprise one or several solar cells, which can be connected to each other in an advantageous manner. It can also be provided that the covering layer comprises several recesses, if the solar module comprises several solar cells, which are possibly arranged spaced from each other. The panel part or the base body can thereby be formed in a planar manner and also in a curved manner in dependence on the respective use. The molding of the solar module in plastic material offers considerable advantages for these geometries, as the exact adjustment o the thin and brittle solar cells at the contour of a curved substrate can otherwise only be effected in an elaborate manner.

In an advantageous arrangement of the invention it is provided that the covering layer is formed as a coating layer and/or as an outer coating film and/or as a glass layer. The enables a variable arrangement of the panel part and a reliable protection of the base body against damaging environmental influences and thus ensures a high-quality optical appearance of the panel part. This embodiment is especially chosen for lids and roofs of vehicles.

If the panel part is to be used in the interior of the vehicle as part of the inner panel, the covering layer can also be formed by a plastic material layer. These plastic material layers are for example known from dashboards in passenger vehicles. In addition to the optical effect, they also have the object to adjust the haptics of the surface.

In a further advantageous arrangement of the invention, it is provided that the covering layer of the panel part is essentially opaque and/or colored. This enables an optically advantageous integration of the panel part in the outer panel of a bodywork of the motor vehicle compared to the state of the art, whereby an optically coherent entire appearance of the motor vehicle is enabled. The covering layer can for example have the same color for this as the remaining bodywork components or have a color or a color progression adapted to the optical surroundings of the vehicle in dependence on the respective arrangement of the panel part. Alternatively or additionally, an optical improvement of the panel part can also be achieved by an opaque, cloudy or milky design of the covering layer.

Further advantages result in that the recess is covered by a further covering layer, especially a UV protection layer and/or a scratch protection layer and/or a covering coating layer and/or a transparent film. This enables a further improvement of the optical long-term properties due to the improved protection against undesired environmental influences with regard to appearance and with regard to the efficiency of the solar module.

A UV protective coating is especially advantageous in connection with polycarbonate glasses as plastic material. If plexiglass (PMMA) is used as plastic material, scratch-proof coatings are preferably used.

An improvement of the mechanical properties of the panel part is achieved in that the base body additionally comprises at least one stiffening element, especially a structural beam and/or a fiber reinforcement. This permits the formation of panel parts with large base areas, so that the panel part can for example be used as the roof of a motor vehicle. The structural beams preferably project over the plastic material of the base body in a suitable manner for fastening to the bodywork. An optically advantageous appearance of the panel part can especially be achieved in that the stiffening element is arranged below the opaque or colored covering layer and thus cannot be seen from the exterior.

In a further advantageous arrangement of the invention, it is provided that the panel part is formed as a self-supporting panel part and/or covering part and/or roof and/or sliding roof and/or front hood and/or rear lid. This enables a particularly flexible use of the panel part in dependence on the respective design of the motor vehicle.

A further embodiment of the panel part is formed by the dashboard or hat shelf in motor vehicles.

It has thereby further been shown to be advantageous that the solar module of the panel part can be coupled to an energy storage element, especially a battery of an electric drive of a motor vehicle, and is designed to supply the energy storage element with electrical energy. In this manner, the advantages which can be achieved by the panel part according to the invention can be used for saving energy in an optimal manner with regard to a higher efficiency of the solar module with an optically advantageous appearance and low weight. If the motor vehicle is formed as a hybrid vehicle or electric vehicle, the panel part according to the invention can thus provide at least a part of the necessary drive energy.

A further aspect of the invention relates to a method for producing a panel part for a motor vehicle, where at least one solar module is connected to a base body of the panel part consisting at least partially of a transparent plastic material by molding into the plastic material. Injection molding and/or an injection compression molding and or molding are suitable as molding methods. The solar module is arranged in such a manner that its bottom side is maximally not molded This can for example take place in that the solar module is placed on one of the mold sides or mold halves with its bottom side.

In an advantageous arrangement, a covering layer is simultaneously also molded during the molding of the solar module. An improved optical property of the panel part is created in that a recess associated with the at least one solar module is brought into the covering layer. This effects an improved light entry into the plastic material of the base body which is transparent at least in this location, whereby the efficiency of the solar module is increased advantageously due to the decreased optical scattering and absorption losses. Further resulting advantages can already be taken from the previous descriptions. The covering layer can for example be placed into the upper mold half of a mold with two halves and the solar module can be deposited on the lower mold half.

A further arrangement provides the essentially complete molding of the solar module. It has thereby been shown to be advantageous that, for connecting the at least one solar module to the base body, the at least one solar module is possibly arranged within a mold half of a molding device by means of a spacer, and the base body is produced by means of an injection molding method and/or an injection compression molding method and/or a molding method. By using an injection compression molding method, the base body can additionally be produced in a highly exact manner, whereby optically advantageous, low gap amounts are achieved. Additionally, large dimension panel parts—as for example roof parts—can be produced without problems and with a high exactness. The geometry of the base body can thereby be chosen in a virtually optional manner, so that it or the panel part can be produced in a planar and also in a curved manner. The same advantages can also be achieved by the use of a molding method, which is also advantageously suitable for mass production of simple and also complicated geometries. The solar module can thereby optionally lie on the mold half and thus only partially be molded into the plastic material. The solar module can alternatively be arranged in a spaced manner to the mold half by means of a spacer and thus be embedded in the plastic material from all sides. The mold half can thereby be formed in a planar or a curved manner in dependence on the desired geometry of the base body. It can thereby also be provided that a possible stiffening element is also arranged in the mold half and is molded therewith. A corresponding cavity can inversely also be provided, in which the stiffening element is arranged subsequently and possibly fixed by glueing.

It has thereby further been shown to be advantageous that, for connecting the base body to the covering layer, the covering layer adapted to an outer surface of the panel part, into which is brought the recess associated with the at least one solar module, is initially arranged at a further mold half of the molding device adapted to an outer contour of the panel part, and is connected to the base body by the injection molding method and/or injection compression molding method and/or molding method. This enables a simultaneous connection of the solar module and the covering layer to the base body in one method step, whereby considerable time and cost advantages are achieved. The further mold half can thereby also be formed in a planar or curved manner in dependence on the desired geometry of the base body.

It has thereby been shown to be particularly advantageous during the production of curved panel parts that the covering layer is molded prior to the arranging in the mold half by means of a thermal molding method. The covering layer thus already has the desired geometry prior to the connection to the base body, whereby the formation of optically undesired surface irregularities is avoided in a particularly reliable manner. It can thereby be provided that the recess is introduced into the covering layer by a separating method before or after the thermal molding method.

Further advantages result in that a transparent plastic material layer is additionally molded to the covering layer in the region of the recess. This enables an improved protection of the surface of the base body in the region of the recess against scratching, increased UV load and the like.

A further advantageous possibility for introducing the recess into the covering layer is given in that the covering layer is glued to the base body in such a manner that the covering layer has the recess associated with the at least one solar module. In this manner, it is not necessary to bring the recess into the covering layer in an additional procedure.

It has thereby been shown to be advantageous in a further arrangement of the invention that a poly(methyl)methacrylate and/or a polycarbonate and/or a cyclo olefin copolymer and/or a liquid crystal polymer is used as plastic material. Polymethylmethacrylate (PMMA) is thereby a shatterproof and light substitute for glass. Polycarbonates have the advantage that they are very dimensionally stable on the one hand and can be welded and glued in a simple manner, and also have a high impact resistance. Cyclo olefin copolymers have a high heat form resistance and can be adapted optimally to the respective usage purpose of the base body by varying the educts. Liquid crystals have excellent mechanical and chemical properties on their part and also have a high resistance force with regard to environmental influences in addition to a high tensile strength.

Further advantages, characteristics and details of the invention result from the following descriptions of an embodiment and by means of the drawing. The only FIGURE thereby shows a schematic lateral sectional view of a panel part according to one embodiment.

The only FIGURE, in which the same or functionally the same elements are provided with identical reference numerals, shows a schematic lateral sectional view of a panel part for a motor vehicle according to an embodiment. The panel part, which is formed as a sliding or light roof for a hybrid vehicle (not shown) in the shown embodiment, thereby comprises a base body 10, which consists completely of a transparent plastic material 12 in the present example and whose outer side is covered by a covering layer 14. Polymethylmethacrylate is thereby used as plastic material 12, which represents a shatterproof and light substitute for glass. Other suitable plastic materials such as polycarbonates, cyclo olefin copolymers or liquid crystal polymers can alternatively also be used. The base body 10 further carries a solar module 16, which comprises a plurality of solar cells 16a-e connected to each other and is known from the state of the art. The shown solar module 16 thereby enables a power output of up to 300 W and can advantageously be coupled to an energy storage unit of an electric motor of the hybrid drive. The covering layer 14, which is presently formed as an outer coating film colored in the motor vehicle color and is opaque, has thereby a recess 18 in the arrangement region of the solar module 16 associated therewith, which enables the entry of light 20 to the solar module 16 through the plastic material 12. The base body 10 additionally has several reinforcing elements 22, which comprise metallic structural beams 22a and also fiber reinforcements 22b. The reinforcing elements 22 are thereby arranged below the covering layer 14 and can thus not be seen from the exterior. This ensures an advantageous optical impression of the panel part, which can blend harmonically into a bodywork after the assembly.

The shown panel part is produced by bringing the covering layer 14 provided with the recess 18 into a mold half of an injection molding device representing the outer contour of the base body 10. The covering layer 14 can possibly be molded into a desired three-dimensional form by means of a thermal molding method beforehand. This is especially suitable if the base body 10 shall have a curved outer contour. The solar module 16 is placed into the further mold half of the injection molding device, wherein a correct alignment with regard to the recess 18 arranged in the first mold half has to be observed. The solar module 16 can thereby optionally lie on the molding half or be arranged with a predeterminable distance to the mold half by means of a spacer. The reinforcing elements 22 can also be arranged in one of the two molding halves. Corresponding recesses can alternatively also be provided, into which the stiffening elements 22 are subsequently inserted or glued. The two molding halves are subsequently closed and the plastic material 12 is injected, whereby the base body 10 is formed and connected to the covering layer 14 and to the solar module 16. It can alternatively also be provided that the solar module 16 is covered with the transparent plastic material 12 and is back injection molded with a further plastic material, not necessarily transparent. The injection molding method thereby enables a significant reduction of the production time and of the production costs compared to for example a laminating method. Instead of the injection molding method, an injection compression molding or a molding method can also be used, which enable the same advantages. Alternatively, the base body 10 can initially be produced with the solar module 16 and possibly the reinforcing elements 22 and the covering layer can subsequently be glued thereon.

1. A panel part of the outer panel or inner panel of motor vehicles with a base body (10), which consists at least partially of a transparent plastic material (12) carrying at least one solar module (16), and where the plastic material entirely surrounds the solar module (16) in a form-fitting manner, at least on the sun-facing side or the outer side of the panel part, wherein the sun-facing side or outer side of the panel part is covered, at least in sections, by an essentially opaque and/or colored covering layer (14), which has a recess (18) associated with the solar module (16), at least in the arrangement region thereof.

2. The panel part according to claim 1, wherein the solar module (16) is molded into the plastic material (12).

3. The panel part according to claim 1, wherein its outer side forms the surface of a self-supporting panel part and/or covering part and/or roof and/or sliding roof and/or glazing and/or front hood and/or rear lid.

4. The panel part according to claim 3, wherein the covering layer (14) is a coating layer and/or an outer coating film and/or a glass layer.

5. The panel part according to claim 1, wherein the recess (18) is covered by a UV protection layer and/or a scratch protection layer.

6. The panel part according to claim 1, wherein its sun-facing side forms the surface of an interior panel of a motor vehicle, especially dashboard or hat shelf.

7. The panel part according to claim 6, wherein the covering layer (14) is a plastic material film.

8. The panel part according to claim 1, wherein the base body (20) additionally comprises at least one stiffening element (22), especially an at least partially molded structural beam (22a) and/or a fiber reinforcement (22b).

9. The panel part according to claim 1, wherein the solar module (16) of the panel part is adapted to be coupled to an energy storage element, especially a battery of an electric drive of a motor vehicle, and is designed to supply the energy storage element with electrical energy.

10. A method for producing a panel part for a motor vehicle by connecting at least one solar module (16) to a base body (10) of the panel part consisting at least partially of a transparent plastic material (12), comprising:
the solar module (16) into the plastic material, so that at least the sun-facing side or outer side of the panel part is molded in completely, and
simultaneously molding a covering layer (14) to the sun-facing side during the molding of the solar module (16), which side has at least one recess associated with the solar module (16).

11. The method according to claim 10, wherein for molding the at least one solar module (16) in the base body (10), the at least one solar module (16), possibly by means of a spacer, is arranged within a molding half of a molding device and that the base body (10) is produced from the plastic material (12) by means of an injection molding method and/or an injection compression molding method and/or a molding method.

12. The method according to claim 10, wherein for connecting the base body (10) to the covering layer (14), the covering layer (14) adapted to an outer surface of the panel part, into which is brought the recess (18) associated with the at least one solar module (16), is initially arranged at a further mold half of the molding device adapted to an outer contour of the panel part, and is connected to the base body (10) by the injection molding method and/or injection compression molding method and/or molding method.

13. The method according to claim 12, wherein the covering layer (14) is molded by means of a thermal molding method prior to the arrangement in the further molding half.

14. The method according to claim 12, wherein a transparent plastic material layer is additionally molded to the covering layer (14) in the region of the recess (18).

15. The method according to claim 10, wherein a polymethylmethacrylate and/or a polycarbonate and/or a cyclo olefin copolymer and/or a liquid crystal polymer is used as plastic material (12).
